(19) United States
(12) Patent Application Publication
(10) Pub. No.: US 2025/0077974 A1
(43) Pub. Date: Mar. 6, 2025

(54) SYSTEM AND METHOD FOR FOR LOW SAMPLE RAPID CLASS AUGMENTATION USING A RIDGE REGRESSION COST PENALTY

(71) Applicant: Leidos, Inc., Reston, VA (US)

(72) Inventor: Hanna Witzgall, Chantilly, VA (US)

(73) Assignee: Leidos, Inc., Reston, VA (US)

(21) Appl. No.: 18/816,001

(22) Filed: Aug. 27, 2024

Related U.S. Application Data
(60) Provisional application No. 63/579,151, filed on Aug. 28, 2023.

(51) Int. Cl. G06N 20/00; G06F 18/2431; G06V 10/764; G06V 10/766; G06V 10/774

(52) U.S. Cl. CPC G06N 20/00; G06F 18/2431; G06V 10/764; G06V 10/766; G06V 10/774

(57) ABSTRACT

Ridge Regression for Rapid Class Augmentation (R3CA), a regularized version of the XRCA incremental learning algorithm, implements an unconstrained, recursive least-squares (RLS) style of optimization that incorporates knowledge of all the past training examples into each optimization step by recursively computing an IFCM in a single multi-class prediction head. The single multi-class prediction head receives class token feature vectors from a pretrained, self-supervised, vision transformer model and is able to achieve the same optimal performance as a non-incrementally trained classifier in a jointly optimal manner over a set of increasing classes. R3CA excels at low sample incremental learning applications.

### CROSS-REFERENCE TO RELATED APPLICATIONS

The present application claims the benefit of priority to U.S. Provisional Patent Application No. 63/579,151 entitled RIDGE REGRESSION FOR RAPID CLASS AUGMENTATION filed Aug. 28, 2023, which is incorporated herein by reference in its entirety.

Cross-reference is made to commonly-owned U.S. application Ser. No. 17/083,969 entitled DEEP RAPID CLASS AUGMENTATION filed Oct. 29, 2020, U.S. application Ser. No. 17/840,238 entitled METHOD AND SYSTEM FOR ACCELERATING RAPID CLASS AUGMENTATION FOR OBJECT DETECTION IN DEEP NEURAL NETWORKS filed Jun. 14, 2022 and to U.S. Provisional Patent Application No. 63/579,144 entitled JOINTLY OPTIMAL INCREMENTAL LEARNING WITH SELF-SUPERVISED VISION TRANSFORMERS filed Aug. 28, 2023, each of which is incorporated herein by reference in its entirety.

### BACKGROUND

### Field of Embodiments

Generally, the field is continuous learning algorithms. More specifically, the field of the embodiments is incremental learning algorithms that excels in low sample support environments and retains the ability to sequentially learn new classes while preserving performance on prior classes.

### Description of Related Art

Continuous learning (CL) algorithms are essential in the development of intelligent AI agents so that they can learn new tasks after deployment and adapt to real world experiences. Currently, most neural networks use training techniques that are incapable of learning new tasks in an efficient, sequential, online manner without significantly degrading their performance on previously learned tasks. This means that most machine learning models require retraining over all the data, both new and old, every time new class data becomes available. This quickly becomes infeasible for AI agents trying to operate and adapt in dynamic real-world and real-time environments.

The problem of ‘catastrophic forgetting’ (CF) is so central an obstacle to the goals of continuous learning that a sub-field of CL has arisen called incremental learning that primarily focuses just on its solutions. The reason that CF occurs is because standard optimizers have no long-term memory and update their weights using just the data in the current batch. When used for incremental learning, where the new training data consists only of the new class, a standard optimizer will overfit the model to the new class and gradually forget that previous classes existed.

Many approaches have been explored to address CF in incremental learning. Incremental learning methods often seek to improve performance by finetuning a pretrained network's feature extraction backbone incrementally on each new class while learning the new class weights. Maintaining earlier class performance while optimizing the backbone on just the new class data is difficult, since now the features used in the training of earlier classifications have been changed.

Most incremental learning methods approach this challenge by adding some sort of memory component to the new class update in order not to forget or degrade features from prior classes. These approaches can be roughly categorized into three groups based on their different approaches on how to incorporate memory into the incremental updates: replay/rehearsal; regularization; and ensemble/parametric isolation methods.

Replay or rehearsal methods are principally characterized by their use of storing samples or pseudo-samples from previous learned tasks and injecting them into the current new class training to mitigate CF. A notable replay method is called iCARL, which stores a subset of exemplars per class, which are selected to best approximate class means in the learned feature space. At test time the class means are calculated for nearest mean classification based on all exemplars.

These types of replay and rehearsal methods have several drawbacks. First, their approach is built around supporting a memory framework of prior class examples that typically grows as additional classes and samples become available. And if these methods do restrict the total number of past samples they store, their performance is seen to suffer as more classes are added under this restriction. This quickly becomes unstainable when operating on long streams of data that contain more and more new classes. Another big drawback of these replay methods is their long inference times due to their frequent use of nearest neighbor classification. This results in significantly slower prediction times than for regular classifiers and decreases their utility for applications in the field where AI agents need to quickly recognize new objects.

Regularization methods are mostly characterized by their use of constraints and cost penalties in their weight updates to ensure that a new task's feature weights cause minimum interference with the important weights from prior classes. For example, the key idea in the well-known Elastic Weight Consolidation (EWC) method is to identify the important features of prior classes using the Fisher Information Matrix and then to penalize changes to those important feature weights during the updates on the new class data. Several other incremental learning methods have grown out of this idea, including Variational Continual Learning.

Another regularization approach seeks to optimize for both high accuracy on the new task and for preservation of responses for the existing tasks from the original network. It works by approximating the original network's output on the new class data and using those soft labels to preserve knowledge of the old network's features given only the new class data. This approach also saw the unexpected benefit of acting as a regularizer to improve test performance for the new classifier. Learning without Forgetting (LwF) is a prominent example of these methods.

A benefit of regularization methods is that they avoid the storing of raw inputs, prioritize privacy, and alleviate memory requirements. In addition, they typically have fast inference times. But they have no theoretical justification for eliminating CF and they have only been shown to operate using single class prediction heads and are therefore unable to jointly optimize over the growing set of classes.

Ensemble and parameter isolation methods are characterized by dedicating different models or a subset of model parameters to each specific task to avoid any interclass interference. When no size constraints are applied, one can grow new branches for each new task while freezing previous task parameters. Alternative methods use a static network architecture with fixed parameters allocated to each task.

Life-long Machine Learning is a type of ensemble method which automatically decides whether a sub-network should be removed or added to the ensemble. PathNet is a parameter isolation method that uses a genetic algorithm to find an optimal path through a fixed size neural network for each session. The weights in this path are then frozen so that when new sessions are learned the knowledge is not lost. A drawback of these ensemble methods is that they typically require a task oracle to identify which corresponding sub-models or branches to use for a particular classification task. This task oracle amounts to a type of inference time label which is often not available and limits their utility.

None of these prior art techniques have been able to consistently demonstrate and theoretically justify the elimination of CF. Furthermore, many incremental learning methods impose additional learning restrictions to simplify the problem. For example, a working assumption in this field is that a model will have access to all a new task's data whenever it is incrementally added. This allows the methods to assume that a new task can be completely learned before moving onto the next task. This assumption also enables offline solutions with their episodic training methods that inhibit CL's goals for online, real-time learning. It also ignores other desirable CL objectives such as providing training techniques with task revisit capabilities or learning without distinct task boundaries on the training batches. A constant memory size is another advantageous attribute that is often ignored in many incremental learning methods.

Accordingly, there remains a need in the art for an online, incremental learning algorithm that incrementally learns new classes without experiencing CF on its prior classes.

### SUMMARY

In a first exemplary embodiment, a system for incrementally training a classifier to continuously learn new classes and classify incoming data includes: a processing component for formatting incoming data for feature extraction; a transformer backbone for multiplying formatted data with a positional embedding, transforming, by an encoder, formatted data with positional embedding to produce an encoded vector, appending a class token to the encoded vector; a single head incremental classifier trained on known classes including a classification weight matrix wₖ, where k denotes the kth training update for receiving the encoded vector and determining that the incoming data is in a new class, wherein upon determining that the incoming data is in a new class classification weight matrix is augmented with a new null-class weight vector Δwₖ, and a feature correlation memory, including a ridge regression penalty applied for regularization, wherein the single head incremental classifier is trained on training data having feature samples corresponding to the incoming data directed to the new class.

In a second exemplary embodiments, a system for incrementally training a classifier for image classification includes: an image processing component for extracting multiple flattened image patches from an input image; a transformer backbone for linearly transforming each of the multiple flattened patches, by a patch encoder layer, and mapping the linear transformation to a patch vector, multiplying each patch vector with a positional embedding, transforming, by an encoder, each patch vector with positional embedding to produce an encoded patch vector, appending a class token to the encoded patch vector; a single head incremental classifier trained on known image classes including a classification weight matrix wₖ, where k denotes the kth training update for receiving the encoded vector and determining that the input image is in a new class, wherein upon determining that the input image is in a new class augmenting the classification weight matrix with a new null-class weight vector Δwₖ, and a feature correlation memory, including a ridge regression penalty applied for regularization, wherein the single head incremental classifier is trained on images having feature samples corresponding to the input image directed to the new class.

In a third exemplary embodiment, a non-transitory computer-readable storage medium having computer-executable instructions stored thereon for predicting an image class, which when executed by one or more processors, cause the one or more processors to perform operations including: extracting multiple flattened image patches from an input image; linearly transforming each of the multiple flattened patches, by a patch encoder layer, and mapping the linear transformation to a patch vector; multiplying each patch vector with a positional embedding; transforming, by an encoder, each patch vector with positional to produce an encoded patch vector; appending a class token to the encoded patch vector; receiving the encoded patch vector at a classifier and determining by a classification weight matrix that the image is in a new class; augmenting the classification weight matrix with a new null-class weight vector; and training the incremental classifier on images having feature samples corresponding to the input image directed to the new class.

### BRIEF DESCRIPTION OF THE FIGURES

Example embodiments will become more fully understood from the detailed description given herein below and the accompanying drawings, wherein like elements are represented by like reference characters, which are given by way of illustration only and thus are not limitative of the example embodiments herein.

FIG. 1 provides a block diagram of an exemplary incremental learning classifier in accordance with an embodiment herein;

FIG. 2 provides experimental results for a XRCA incremental learning base model in accordance with an embodiment herein;

FIG. 3 provides experimental results for XRCA and R3CA incremental learning with small model initialization in accordance with an embodiment herein;

FIG. 4 provides experimental results for XRCA and R3CA incremental learning with low sample support in accordance with an embodiment herein;

FIG. 5 provides experimental results for XRCA and R3CA incremental learning with base model (FIG. 2) and high sample support in accordance with an embodiment herein;

FIG. 6 illustrates unexpected impact of numerical precision on XRCA solutions in accordance with an embodiment herein;

FIG. 7 illustrates the case where a reduced rank PCA-RCA base model is initialized in accordance with an embodiment herein;

FIG. 8 illustrates the case where a PCA-RCA model is initialized with low sample support in accordance with an embodiment herein;

FIG. 9 illustrates the sensitivity of R3CA to the ridge regression proportional penalty, and the sensitivity of PCA-RCA to rank selection in accordance with an embodiment herein; and

FIG. 10 illustrates the case of PCA-RCA model online learning of a single class in accordance with an embodiment herein.

### DETAILED DESCRIPTION

As described herein, the present embodiments are directed to an online, incremental learning algorithm called Ridge Regression for Rapid Class Augmentation (R3CA). R3CA is based on a regularized version of the extending Rapid Class Augmentation (XRCA) algorithm that incrementally learns new classes without experiencing ‘catastrophic forgetting’ on its prior classes. R3CA was developed to improve XRCA's performance in data-starved environments that are common for small model initialization and continuous learning on small streams of increasing information. R3CA uses a ridge regression cost penalty to increase the solution's numerical stability and minimize its overfitting for low sample support use cases. Results demonstrate that the new R3CA algorithm excels in low sample support while retaining XRCA's ability to sequentially learn new classes while preserving performance on prior classes. Experiments show that neither the original XRCA algorithm nor other reduced-rank regularization methods can handle these low sample support scenarios as well. This makes R3CA an attractive option for continuous learning on remote platforms that need to learn on streaming data, in an online and real-time manner while having limited on-board memory and compute resources.

Both XRCA and R3CA differ from many other incremental learning algorithms in that they decouple the optimization of the network's feature extraction backbone from the classifier's update on the new class data. Instead, these techniques use a frozen, pretrained feature extraction backbone and transfer these pretrained features directly to the new downstream task. This allows them to focus on sequentially optimizing a multi-class classifier and not on the additional task of incrementally updating the backbone's feature weights. This simplifies the problem since now during new class training, the optimizer is not changing the backbone weights and thereby the features upon which previous classes are classified.

While a drawback of this approach is that if the pretrained backbone's features do not transfer well to the downstream tasks, classification performance will suffer, with the advent of self-supervised vision models like DINO that can produce class-agnostic features that generalize well to a wide variety of classes, this drawback is greatly mitigated. Additional description of DINO is found in Caron et al., Emerging Properties in Self-Supervised Vision Transformers, arXiv:2104.14294v2 [cs.CV] 24 May 2021 which is incorporated herein by reference.

The success of these pretrained self-supervised backbones increases the utility of incremental learning approaches like XRCA and R3CA that leverage self-supervision's revolutionary capabilities to produce features that transfer well to almost any class. This suggests that it may no longer be necessary for incremental learning approaches to optimize the network's feature extraction backbone individually and consecutively for each new class and deal with all the related issues.

This simplified approach enables a recursive online memory solution that allows XRCA and R3CA to optimize over all previously seen training samples and not just the ones in the current batch. This recursive memory is seen to operate equally well on mixed class batches or batches containing just the new classes. Data order becomes irrelevant, and an incrementally trained classifier is seen to obtain the same performance as a non-incrementally trained classifier.

This approach also seamlessly provides other important CL attributes such as having a constant memory, online learning, training without task boundaries and with the ability to revisit tasks to improve performance. Many of these attributes are lacking in other incremental learning approaches.

In other words, R3CA's recursive memory eliminates the CF that plagues standard optimizers and other specialized incremental learning methods. As discussed in detail below, R3CA is able to jointly optimize over a set of classes that are added sequentially and to incrementally learn classes with a final classification accuracy that matches or even exceeds the accuracy of the non-incremental solution with its access to all the training data upfront.

Theoretically, this approach is justified by the equivalence of a recursively computed inverse feature covariance method (IFCM) with its non-recursive computation, via the Matrix Inversion Lemma. To our knowledge, these two approaches are the only incremental learning methods that can consistently demonstrate and theoretically justify the elimination of CF while jointly optimizing over sequentially learned classes.

The new R3CA method is distinct from XRCA in its use of a ridge-regression constraint in its cost function to regularize its weight updates. The new regularized update is shown to significantly improve XRCA's performance in data starved environments that are important for model initialization with few initial training examples. Furthermore, R3CA is shown to be much more robust and computationally efficient to the sequential addition of future classes than other subset forms of regularization such as rank reduction. This makes R3CA an attractive technology for applications requiring continuous learning with streaming supervised data, in real-time, and on platforms with challenging size, weight, and power (SWaP) constraints.

XRCA and R3CA are somewhat similar to regularization approaches in the sense that they utilize a constant memory component that does not grow as additional data samples are added. And they are like some regularization approaches in that they embed a form of knowledge or memory of prior classes into the optimization step to reduce the forgetting of prior classes during new class training. But their memory approach is distinct from other regularization approaches that add optimization constraints and cost penalties to minimize the interference of a new class's updates with previously learned classes.

Both XRCA and R3CA use an unconstrained, recursive least-squares (RLS) style of optimization that incorporates knowledge of all the past training examples into each optimization step by recursively computing an IFCM. In this way, they effectively negate all the typical forgetting issues that arise in standard batch-based optimization techniques like stochastic gradient descent that retain no memory of prior classes outside of the current batch. This is demonstrated by both XRCA and R3CA achieving the same optimal performance as a non-incrementally trained classifier and doing so in a jointly optimal manner over a set of increasing classes using a single multi-class prediction head.

These approaches have demonstrated extremely rapid training rates. XRCA has been shown to train 1000's of times faster than conventional approaches which require retraining over large numbers of classes in order not to experience CF. This speed improvement is mostly attributed to XRCA and R3CA's ability to sequentially learn using just the new class data. However, some of their speed-up is also due to their ability to jointly update all the classes at once with the use of a single multi-class prediction head. Most other incremental learning methods require a separate prediction head for each task. These prediction heads are usually retrained whenever a new class is added to adjust these classifiers to the newly finetuned features. In contrast, XRCA uses a single, multi-class prediction head that can jointly optimize over all classes at once. This multi-class prediction head architecture also translates into faster prediction times.

Another important distinction between XRCA/R3CA and other incremental learning approaches is that they do not seek to optimize a network's feature extraction backbone while training a classifier on a new class. Instead, they focus on just optimizing a network's multi-class classifier and leave the feature optimization to a pretrained feature extraction network.

Before the recent emergence of self-supervised vision backbones, it was standard practice to finetune a feature extraction backbone that was pretrained on a large, supervised data set for the new downstream task. This downstream finetuning often considerably improved the performance from the original pretrained supervised features that were optimized to respond to a different set of tasks. For CL applications, this type of finetuning is often impractical since the future classes are either not known or not yet available. Further, it is often not desirable to have to save all the data from previous classes in order to learn a new class.

This created a demand for incremental learning methods that could incrementally finetune a network's backbone while not degrading the performance of previously learned classes. This is extremely challenging since the optimizer is now changing the feature weights for previously trained classes based only on the new class data. We question if there is still a compelling need to incrementally finetune features on the new class data given the success of self-supervised vision backbones that produce class-agnostic features by learning without explicit labels. Indeed, we leverage self-supervised feature extraction backbones to allow both XRCA and R3CA to focus on the sequentially training the classifier.

The XRCA method extends the RLS algorithm for the task of sequential learning. The RLS algorithm is classically known as an adaptive online filtering technique that efficiently finds an updated least squares (LS) solution given a stream of data. The RLS algorithm avoids the repeated computational cost of LS's matrix inversion for each new sample by using the Matrix Inversion Lemma. This enables it to efficiently compute and quickly adapt to changing data statistics in an online manner and on a sample-by-sample update if desired.

The embodiments described herein view continuous learning as a recursive process and we adapt the classical RLS regression task to classification by extending the regression weight vector into a classification weight matrix where each column of the matrix estimates the likelihood of a different class. Importantly, RLS IFCM serves as the optimizer's memory and, together with its memory parameter lambda, gives it a weighted memory of all previous training examples. By setting the RLS memory parameter lambda to 1, one can essentially include a stream of never-ending data into the classifier's weight estimation. This can be used to improve the classifier's performance with additional information gathered over long data streams.

The classification task is adapted for incremental learning by augmenting the existing classifier matrix with a new column for the new class weights. When this class's weight vector is matrix-multiplied by a sample's feature vector then it should produce either a +1 or −1 depending on whether that sample is associated with the class's weight vector.

A critical element of the XRCA algorithm is how these new class weights are initialized. Instead of initializing the new class weights randomly, the XRCA algorithm recursively computes and maintains a novel null-class weight vector that is used to initialize any new class. This new type of weight initialization is based on the key insight that any new class's column vector weights are simply weights that have not yet seen any positive class examples. Since these classification weights are updated recursively and the new classes have not been seen before, then the initial LS estimate for the new class weight vector is just the recursive solution of all the preceding examples when they are given a negative label.

In other words, by training a null-class weight vector over all the previously seen training data using a negative label we have the optimal LS initialization for any new class. After this null-class initialization, the augmented classification matrix can be recursively updated with RLS using batches containing some or none of the new class training examples.

Importantly, this type of recursive update means that the order with which the samples arrive is unimportant. The algorithm will achieve the same performance if run sequentially on batches containing just new data, or batches with class mixtures. This approach enables XRCA to operate with constant memory, in an online manner (without offline episodic training), and with no task boundaries and no limitations on revisiting old tasks.

Embodiments herein present different ways to regularize the XRCA algorithm to improve its operation in low sample support use cases where it either fails or overfits. This is an important use case for progressive learning algorithms that often want to start small and incrementally grow their model's capacity as more data becomes available. Regularization methods are often used to avoid overfitting when training with limited data. These techniques trade increased training error for a decreased training prediction variance or model complexity. This bias-variance tradeoff can often help models generalize better to test data and reduce their test prediction error. It is often accomplished by either shrinking the weight values or using a subset selection that sets some of the weights to zero.

Ridge regression is a shrinkage form of regularization that finds a penalized LS solution where the amount of the penalty is determined by the L2 norm of the solution's weights. This method encourages smaller weights which reduce a model's sensitivity to slight changes in the input features and can reduce test-time error. An advantage of shrinkage methods is that their performance relative to their regularization hyperparameter is more continuous and therefore typically more robust to that hyperparameter's selection. Principal component analysis (PCA) is a subset form of regularization that retains a subset of the important feature parameters and sets the rest to zero. It also trades increased training bias for decreased model complexity and better generalization. PCA works by projecting high-dimensional sample features into a smaller subspace where it can reduce the sample noise. These reduced rank methods are also often used to find LS solutions to classically underdetermined problems when the number of samples is less than the data's feature dimensions.

Embodiments herein investigate the benefits of different regularization approaches when integrated into an XRCA incremental learning algorithm. Specifically, the performance of ridge regression's shrinkage approach to regularization is contrasted with a reduced rank subset method of regularization. We used the Stanford CARS data set to assess sequential classification accuracy, computational efficiency, and robustness to hyperparameter selection.

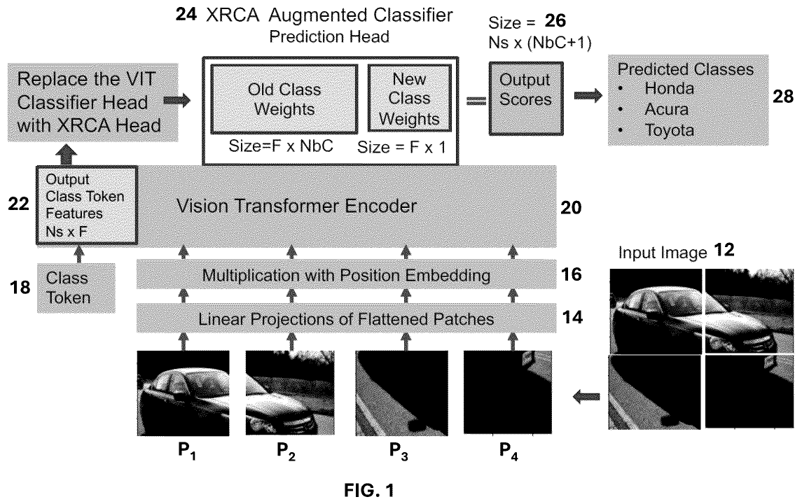

FIG. 1 shows the block diagram of the proposed architecture 5 which is essentially a vision transformer (VIT) network with its classifier replaced with an XRCA or R3CA incremental learning prediction head. More specifically, the inputs to the architecture are images 12 divided into a grid of non-overlapping contiguous square image patches of resolution N×N (e.g., N=16 or N=8). The patches are flattened and then passed through a feed forward layer to form a set of linear patch projections 14 of P₁, P₂ . . . P_{X} which are multiplied with some positional coding 16, and appended with a learnable token, e.g., class token 18, to form a high-dimensional vector representation, e.g., matrix, which is then fed into the vision transformer encoder 20. The role of class token 18 is to aggregate information from the entire sequence.

The transformer encoder 20 uses a series of transformer blocks, each transformer block including a multi-head self-attention layer and a feed-forward layer. Each multi-head self-attention layer contains multi-head attention (MHA) modules used to find the important correlations between the layer's separate token embeddings. The MHA outputs from each layer are summarized using a multi-layer perceptron (MLP) module and the MLP outputs serve as the new token embeddings for the next layer. The final layer's class token is used as the feature vector 22 that summarizes the image and is fed into the network's classifier 24. FIG. 1 shows that the standard VIT's classifier module is replaced with an XRCA incremental learning classification head.

In the image classification domain, each self-attention layer calculates attention weights for each pixel in the image based on its relationship with all other pixels, while the feed-forward layer applies a non-linear transformation to the output of the self-attention layer.

The resulting class-token embedding 22 is the feature vector upon which the XRCA or R3CA classifier 24 operates to generate output scores 26 and assign a class prediction 28. During incremental training, when a new image class becomes available, the R3CA classification matrix is augmented with a new null-class vector and then trained on feature samples corresponding to the new image and label. During inference, the R3CA classifier operates on a feature embedding and outputs a classification score 26 that is jointly optimized over all classes in the training set.

Additional details describing the use of multi-head attention layers in transformer encoders can be found in Vaswani et al., Attention Is All You Need, NIPS (2017), which is incorporated herein by reference. Additional details describing the use of transformer architectures for computer vision can be found in Dosovitsy et al., An Image is Worth 16×16 Words: Transformers for Image Recognition at Scale, rXiv:2010.11929v2 [cs.CV] 3 Jun. 2021 which is incorporated herein by reference.

The weights of the VIT encoder 15 are pretrained on the ImageNet dataset using the DINO algorithm for the pretraining task. The architecture has a patch size of 8, a feature dimension of 768, and 6 multi-prediction heads in each of the 12 encoder layers. The class token features 20 from the VIT backbone are used by the incremental classifier 10 for both training and inference.

The XRCA method is based on a modified RLS to address the incremental learning task and is described in detail in co-owned U.S. application Ser. No. 17/083,969. An XRCA model consists of 3 core elements: 1) a classification weight matrix, wₖ, 2) an inverse feature covariance matrix (IFCM), Mₖ; and 3) a null class vector Δwₖ where the subscript k denotes the kth training update. The weight matrix serves as the prediction head and maps a network's features to its existing classes. The IFCM stores previously seen feature correlation data and acts as the model's long-term memory. The null-class vector is used to initialize a new class using given a negative label on all prior class data.

An XRCA base model w₀ is initialized using the LS normal Eq. (1):

$${w}_{0} = {( {X}_{0}^{T} {X}_{0} )}^{- 1} {X}_{0}^{T} {T}_{0} \qquad ( 1 )$$

where the data matrix X₀∈ [symbol] ^{N×F} consists of a vertically stacked data matrix of N training examples each of feature dimension F, and the label matrix T₀∈ [symbol] ^{N×C} which contains the signed, one-hot class labels of size N×C where C is the number of classes.

To implement XRCA, the normal equations are rewritten using the initialized inverse feature covariance matrix M₀ as shown in Eq. (2) below.

$${M}_{0} = {( {X}_{0}^{T} {X}_{0} )}^{- 1} \qquad ( 2 )$$

$${w}_{0} = {M}_{0} {X}_{0}^{T} {T}_{0}$$

$$Δ {w}_{0} = {M}_{0} {X}_{0}^{T} {T}_{Neg}$$

These three regularized elements: M₀∈ [symbol] ^{F×F}, w₀∈ [symbol] ^{F×C}, Δwₖ∈ [symbol] ^{F×1} make up the components of an XRCA base model and will be recursively updated as the additional data is presented. The T_{Neg} term appearing in the null class's Δwₖ equation consists of a vector of −1's of dimension N×1, representing negative labels for all base model examples.

For each new batch of additional training data, the XRCA algorithm first looks to see if any samples in the batch contain new class labels. If a batch contains only existing class data (i.e., all class labels are less than the number of columns in the current classifier), the XRCA algorithm computes the RLS updates and the new update for the null-class initialization vector Δwₖ, as seen below in Eq. (3)

$${M}_{k + 1} = {M}_{k} - {M}_{k} {{x}_{k + 1}^{T} ( 1 + {x}_{k + 1} {M}_{k} {x}_{k + 1}^{T} )}^{- 1} {x}_{k + 1}^{T} {M}_{k} \qquad ( 3 )$$

$${w}_{k + 1} = {w}_{k} + {M}_{k + 1} {x}_{k + 1}^{T} ( {T}_{k + 1} - {x}_{k + 1}^{T} {w}_{k} )$$

$$Δ {w}_{k + 1} = Δ {w}_{k} + {M}_{k + 1} {x}_{k + 1}^{T} ( {T}_{Neg} - {x}_{k + 1}^{T} {w}_{k} )$$

If a batch contains a new class label (i.e., the number of labels is greater than the number of columns in the current classifier), the XRCA algorithm first augments the existing classification matrix wₖ, with a null-class vector Δwₖ as shown in Eq. (4).

$${w}_{k} = [ {w}_{k ,} Δ {w}_{k} ] \qquad ( 4 )$$

The new augmented classifier wₖ is then passed to the update equations in Eq. (3) and trained with the new xₖ₊₁ training data sample or batch.

R3CA uses ridge-regression to regularize XRCA. Ridge regression adds a cost penalty to the standard loss function that is proportional to the norm of its solution's weights. The new cost function is shown in Eq. (5):

$${Cost}^{Ridge} = {( {T}_{k} - {X}_{k} {w}_{k} )}^{T} ( {T}_{k} - {X}_{k} {w}_{k} ) + λ {w}_{k}^{T} {w}_{k} \qquad ( 5 )$$

This cost function prefers solutions that balance the minimization of the weight coefficients with the overall prediction error and is computationally efficient to compute. It is known to improve performance in low sample support scenarios which are statistically noisy.

This ridge regression penalty manifests itself as a weighted diagonal loading term in the computation of XRCA's IFCM. Eq. (6) shows R3CA's base model components with the new regularization parameter λ that determines how much to penalize a solution's use of large weight coefficients.

$${M}_{0} = {( {X}_{0}^{T} {X}_{0} + λ I )}^{- 1} \qquad ( 6 )$$

$${w}_{0} = {M}_{0} {X}_{0}^{T} {T}_{0}$$

$$Δ {w}_{0} = {M}_{0} {X}_{0}^{T} {T}_{Neg}$$

Setting the regularization parameter λ to zero will result in the original, non-regularized XRCA solution. Note that regularization parameter λ used here to determine how much to regularize the cost is distinct from the lambda used in the standard RLS algorithm which is used to control the memory window. Furthermore, for the embodiments herein, the RLS lambda is always set to 1 to allow integration over long data streams.

The regularization parameter λ can be estimated using a cross-validation error metric but as we will later show almost any number greater than 1 will result in significant improvement. This is mainly because λ serves as a diagonal loading factor which ensures that the feature covariance matrix is invertible. However, some amount of additional regularization to reduce model susceptibility to training noise is seen to help in all our experimental cases. This could be due to regularization benefits that mask low sample noise fluctuations or perhaps even quantization noise caused by floating point precision.

After the base model initialization, R3CA follows the XRCA recursive updates shown in Eq. (3). This means that regularizing XRCA with ridge regression adds negligible computational load and retains XRCA's rapid class augmentation rates.

The PCA-RCA incremental learning method uses a well-known reduced rank approach based on principal component analysis (PCA) for regularization. This method finds the eigenvectors of a data matrix or data covariance matrix that span the dominant portions of feature space. The method then projects the features into this subspace. The regularized PCA-RCA's initialization equations are shown in Eq. (7):

$${M}_{0} = {( {P}_{0} {X}_{0}^{T} {X}_{0} {P}_{0}^{T} )}^{- 1} \qquad ( 7 )$$

$${w}_{0} = {M}_{0} {P}_{0} {X}_{0}^{T} {T}_{0}$$

$$Δ {w}_{0} = {M}_{0} {P}_{0} {X}_{0}^{T} {T}_{Neg}$$

Here P is a projection matrix spanning the subspace of the data's dominant eigenvectors which are computed using an SVD of the data matrix X₀. The selected rank or number of eigenvectors used to span the subspace is PCA-RCA's regularization parameter. The rank regularization parameter can also be estimated using cross-validation but its selection is seen to have a much greater impact on performance and is more sensitive to optimal rank selection than the ridge-regression's regularization parameter.

PCA-RCA's update equations are shown in Eq. (8):

$${M}_{k + 1} = {M}_{k} - {M}_{k} {x}_{k + 1}^{T} {{P}_{0} ( 1 + {x}_{k + 1} {P}_{0} {M}_{k} {P}_{0}^{T} {x}_{k + 1}^{T} )}^{- 1} {x}_{k + 1}^{T} {P}_{0} {M}_{k} \qquad ( 8 )$$

$${w}_{k + 1} = {w}_{k} + {M}_{k + 1} {x}_{k + 1}^{T} {P}_{0} ( {T}_{k + 1} - {x}_{k + 1}^{T} {P}_{0} {w}_{k} )$$

$$Δ {w}_{k + 1} = Δ {w}_{k} + {M}_{k + 1} {P}_{0} {x}_{k + 1}^{T} ( {T}_{Neg} - {x}_{k + 1}^{T} {P}_{0} {w}_{k} )$$

Note that in this solution the projection matrix P is not updated after new data and classes are added. This limits this method's ability to adapt to new feature dimensions that could be discriminative for the new classes. In an alternative embodiment, we can incrementally enlarge the eigenspace as additional data and classes are added. However, this is a more involved approach requiring extra overhead of incrementally adding new orthogonal feature dimensions and constantly re-estimating the reduced rank for optimal regularization.

Initially, a first experiment provides a performance baseline of the standard XRCA algorithm operating on the output features of a vision transformer (VIT) model, pretrained on ImageNet using DINO's self-supervision and transferred without any finetuning to 65 classes of the Stanford CARS dataset which contains 16,185 images of 196 classes of cars. The data is split into 8,144 training images and 8,041 testing images, where each class has been split roughly in a 50-50 split. Classes are typically at the level of Make, Model, Year, ex. 2012 Tesla Model S or 2012 BMW M3 coupe.

To highlight XRCA's ability to mitigate CF, the performance of its incremental classifier is compared against the performance of a non-incrementally trained classifier with simultaneous access to all 65 classes using two different test metrics.

The first metric is called the all-class metric which measures classifier performance on test data containing examples of all 65 classes. This metric illustrates the growing capacity of the classifier as it is trained on additional classes. Ideally, after the addition of the final class, an incremental classifier's classification accuracy would equal that obtained by the non-incrementally trained model. This indicates the incrementally trained model's ability to jointly optimize over all classes.

The second metric is called the train-class metric which measures classifier performance over all previously trained test classes. This metric measures the model's ability to remember all the prior classes and avoid CF after the classifier is taught each new class. The ideal performance for this metric could begin somewhat above the non-incremental, joint solution accuracy, but as additional classes are added, and the joint classification problem becomes more challenging, the incremental model's final classification accuracy would fail to meet the non-incremental model's accuracy.

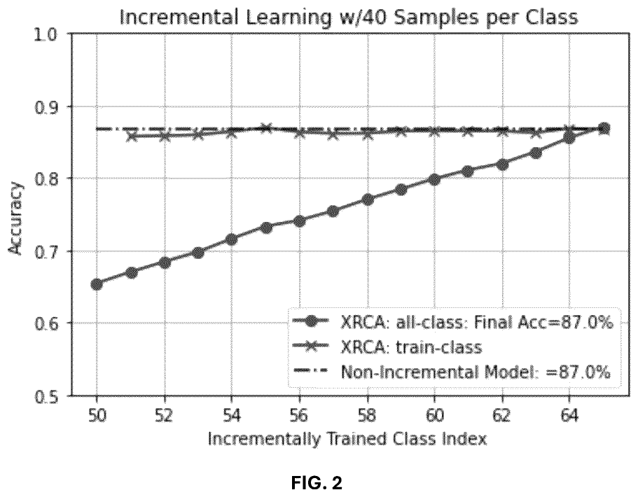

In this first experiment, an XRCA base model is initialized on the first 50 classes and then sequentially trained over the next 15 classes, where each class has approximately 40 train and test samples. FIG. 2 shows the results of this experiment. XRCA's all-class accuracy is seen to linearly progress upward as it is trained on additional classes until it meets the non-sequential model's accuracy (marked by a horizontal black line at its classification accuracy). These results illustrate ideal incremental learning behavior where classification accuracy continues to increase as additional classes are added up to the joint classification accuracy.

Meanwhile, XRCA's train-class accuracy is seen to maintain its performance on previously trained classes as additional classes are added. This indicates that XRCA is not forgetting previous classes and has successfully avoided CF in this sequential learning problem. The reason that the train-class accuracy is not starting above the final non-incremental accuracy is because in this example, the model is initialized on 50 classes and so its train-class accuracy has already basically converged to its average.

These incremental learning results also show a respectable 87% classification accuracy over 65 CAR classes when using DINO's pretrained features without any finetuning or prior exposure to the CARS data. This indicates the power of combining a sequential classifier like XRCA with the class-agnostic features obtained from a pretrained, self-supervised backbone.

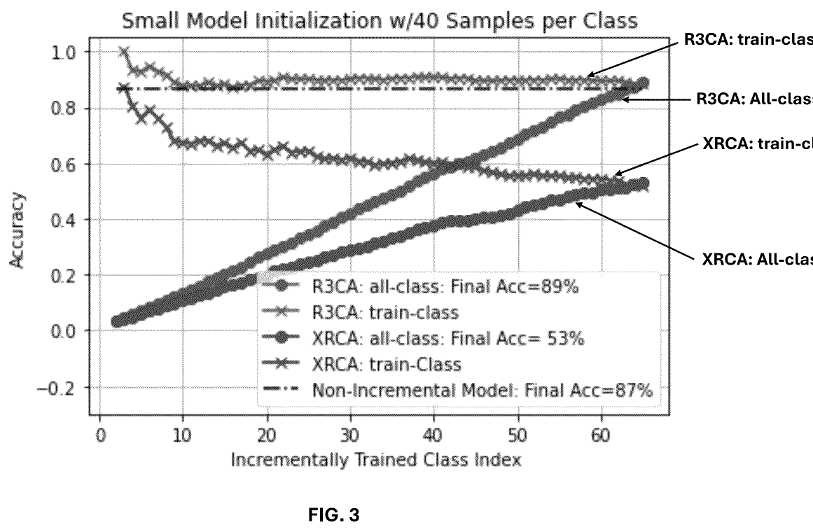

However, in Experiment 2, a problem was observed when we attempted to initialize XRCA using a base model with only two classes. In this case, the XRCA markers in FIG. 3 show that now XRCA's train-class and all-class metrics fail to converge to the non-incremental accuracy after all the classes have been added.

Further examination reveals the problem is primarily due to low sample support which causes the solution to be significantly underdetermined. Since the initial two car classes only contain around 80 samples and DINO's base model produces features of dimension 768, there are many more feature parameters to estimate than there are training samples. This leads to very unstable inverse computations which significantly degrade the solution's classification performance.

Notably, this issue did not occur previously when XRCA was trained on other data sets such as MNIST, CIFAR, ImageNet, and STL10 because each of those data sets has over 1000 samples per class. This meant that even with a two-class classifier initialization, the sample support is still well above the feature dimensions of most pretrained models and the solution was not underdetermined.

The regularized R3CA solution accuracy is shown in FIG. 3. In this experiment, R3CA is given the same amount of training data as XRCA and a regularization parameter of 500. It was initialized on 2 classes and then sequentially trained over the remaining 63 classes. FIG. 3 shows that R3CA's all-class accuracy linearly increases up to the non-incremental model's 65-class accuracy. Similarly, FIG. 3 shows that R3CA's train-class accuracy starts a bit higher than the full joint 65 solution, but never falls below the final joint solution accuracy. This indicates that R3CA is maintaining its prior classes performance as additional classes are added and that it is avoiding CF.

In FIG. 3, note that R3CA obtained a slightly higher classification of 89% than the non-sequential and non-regularized solution of 87%. This suggests that this CARS 65 dataset is still sample support starved and can be improved using regularization methods. This observation is further explored in Experiment 4 discussed below.

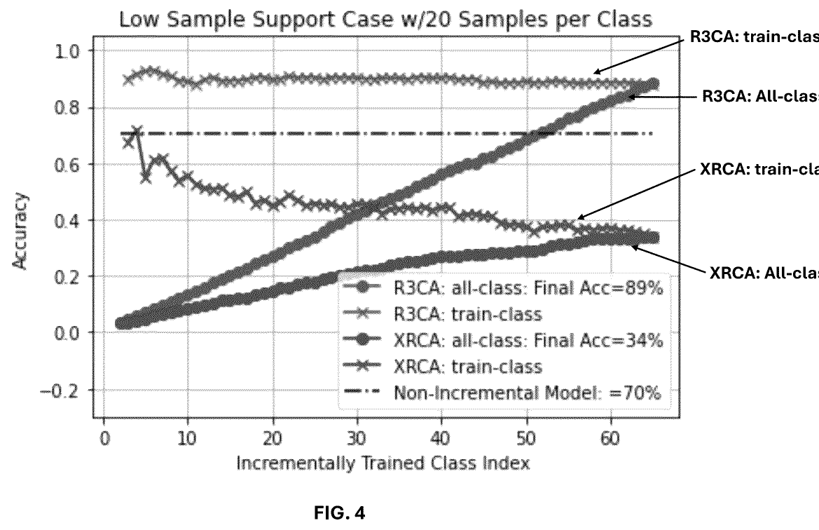

Experiment 3 further tests performance bounds of low sample support. In this experiment, the performance of XRCA and R3CA are compared against each other and the non-incremental solution when provided only 20 training examples per class. FIG. 4 shows the results of this low sample learning case. In this further reduced sample support case, it is not surprising that XRCA continues to struggle to learn the new classes and maintain its performance on previously learned classes. More interesting is that the full, non-incremental, non-regularized, 65 class solution's performance has also dropped substantially from 87% (Experiment 2) to 70% accuracy. This reflects the low sample support starting to impact the normal solution's inverse computation, even when given access to all 65 classes worth of training data.

In this low-sample support case, R3CA is seen to significantly surpass the non-incremental solution. More impressively R3CA is shown to maintain its original 40 sample accuracy of 89% even when trained on half those samples. Additionally, the regularization parameter for R3CA has remained constant at 500 during all the additional new class augmentations and over a wide range of sample count and class augmentations.

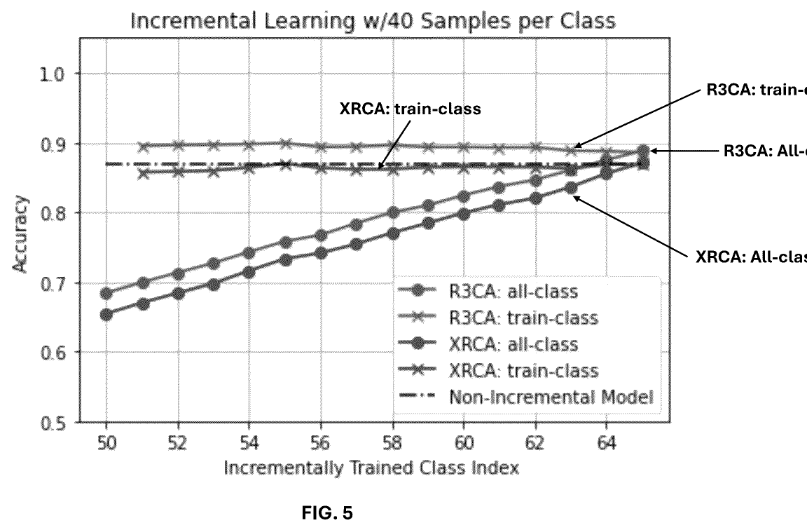

Next, Experiment 4 re-examines the initial scenario which uses all the available sample count of approximately 40 training samples per class, with results shown in FIG. 5. It shows that even in this relatively high sample support case where the number of training samples is much greater than the feature dimension and the feature's covariance matrix (40×65=2600>>768), R3CA continues to provide performance advantages. This supports the claim that ridge regression can improve a classifier's test accuracy by decreasing its complexity and thereby reducing its sensitivity to statistically noisy training data caused by either low sample support relative to model complexity or when test data comes from a slightly different distribution than the original training data. We further speculate that ridge regression also may be helpful reducing model sensitivity to noise caused by statistical mismatches between the self-supervised features and the previously unseen class data those features represent.

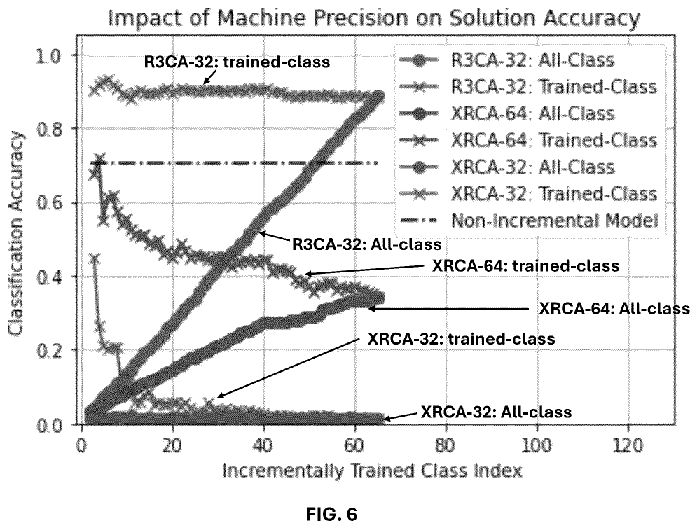

Experiment 5 examines the unexpected impact of numerical precision on XRCA solutions. Three different cases were run: 1) XRCA-64 with the feature matrix data type caser as float64; 2) XRCA-32 with feature matrix using the PyTorch default data type of float32; and 3) R3CA-32 with feature matrix also using the PyTorch default of float32 numerical precision. The Experiment 5 results shown in FIG. 6 indicate that XRCA-32, which involves computing the inverse of a data covariance matrix, is highly susceptible to numerical precision. It further shows that its performance can be significantly improved by increasing its feature data from PyTorch's default type float32 to float64. In addition, it was noted that the typecasting to float64 should take place on the data matrix itself and not after the computation of the covariance matrix or its inverse. This will minimize squaring the quantization noise. In contrast, FIG. 6 shows that R3CA, with its regularized solution, operates just as well with float32 features as it did with double precision (Experiment 3). This ability to operate using only half the numerical precision can be important for agents operating out on the edge with limited compute and memory resources.

The next set of experiments investigates an alternative reduced rank, regularization approach, which is traditionally known to work well in low sample support situations. This PCA-RCA approach computes the principal eigenvectors of the base model's feature covariance matrix, projects sample features into this subspace and computes the LS solution. The results show that this approach can work well for non-sequential applications where the principal eigenvectors represent the subspace they are trained on or where the number of classes and samples in the base model is sufficiently large to enable good discrimination for future classes. However, this method suffers degraded performance if initialized with too small a dataset that has limited dimensionality for future class discrimination.

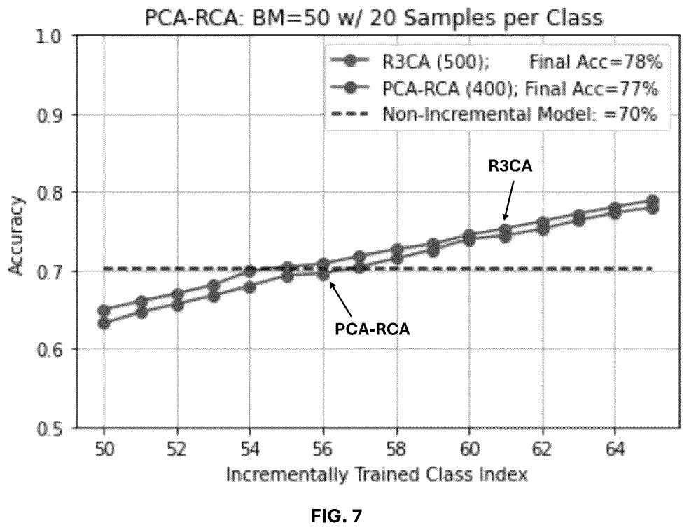

For example, FIG. 7 illustrates the case where a reduced rank PCA-RCA base model is initialized on 50 classes of data, each with 20 samples per class (Experiment 6). The largest 400 eigenvectors of this initial data subspace are estimated, and its base model computed. Subsequent new class data is projected into this eigenvector subspace and the PCA-RCA's all-class accuracy is computed. The results show that PCA-RCA and R3CA perform roughly equivalently in this case with both regularized solutions outperforming the non-incremental and non-regularized solution. The plot's legend shows that R3CA's regularization parameter is still set to 500 and PCA-RCA regularization parameter is set to its dimension rank of 400 eigenvectors.

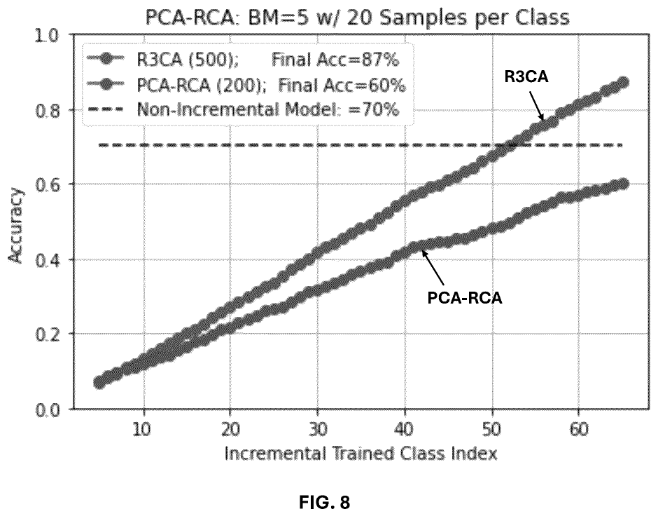

Things change in the next example shown in FIG. 8. Here PCA-RCA data is initialized only on the first 5 classes each with 20 samples per class (Experiment 7). Its regularization rank is now set to 200, which is the highest allowable given initial 200 training samples. For this small 5-class initialization case, both regularized methods perform well initially but as more classes are sequentially added PCA-RCA struggles to match R3CA's performance. This is not that surprising since as more classes are added it becomes more difficult to separate them inside a smaller 200-dimensional subspace that may not incorporate important features of these new classes that fall outside of the initial feature subspace.

Alternatively, a more complicated reduced rank solution could be developed that would gradually add dimensions and enlarge the feature subspace as more class data is added. But progressively growing orthogonal reduced rank approaches is more computationally intensive.

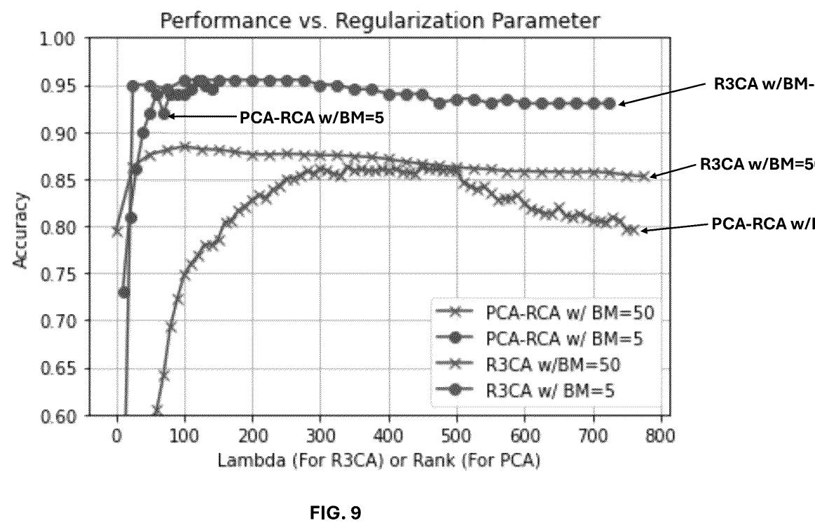

Experiment 8 (FIG. 9) examines the sensitivity of R3CA to the ridge regression proportional penalty, and the sensitivity of PCA-RCA to rank selection. In this example, each class had 30 training examples. The maximum rank for the 5-class base model is therefore only 150 eigenvectors. FIG. 9 shows how the accuracy of these regularized methods change as a function of these parameters for different base model (BM) sizes. Note how R3CA's accuracy varies by only a couple of percent over a wide range of lambdas. This minimizes the overhead of cross-validation for hyperparameter selection since a single lambda could be selected and used for all base model sizes and subsequent new class additions.

In contrast, PCA-XRCA's optimal rank regularization parameter changes significant as more classes and data are added. A PCA base model (BM) with only 5 classes is constrained to its number of samples which in this case is about 150. As the number of classes in the PCA-XRCA base model increases to 50 the optimal rank increases to around 400. Thus, a competitive reduced rank PCA-RCA method would involve the additional overhead computation of growing an orthogonal subspace and constantly re-evaluating its optimal subspace rank.

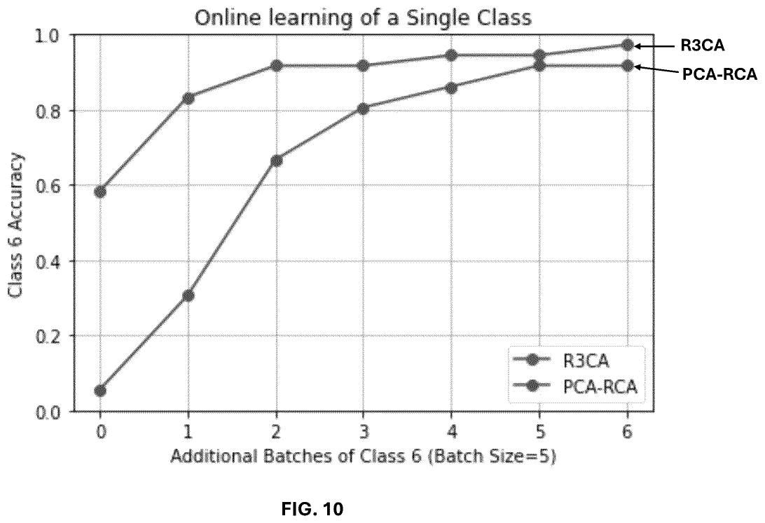

Finally, Experiment 9 (FIG. 10) shows how both R3CA and PCA-RCA inherit XRCA's online learning ability. In this experiment a 5-class base model has a 6th class added to it incrementally in batches of size 5. It shows the online learning of the new class accuracy as more samples are added. These results illustrate that both R3CA and PCA-RCA can learn in an online, non-episodic manner.

As described herein the R3CA regularization method improves incremental learning in low sample support environments. This is an important use case since many incremental learning applications need to start small and sequentially grow their model's capacity as more class data becomes available. The R3CA, based on the XRCA underlying model, inherits XRCA's continuous learning attributes that eliminate catastrophic forgetting, jointly optimizes across all sequentially added classes, has constant memory, performs online learning, learns without task boundaries, and provides the ability to revisit tasks, many of which are often lacking in other approaches. In addition, the R3CA regularization approach can use many fewer training examples to initialize and incrementally grow its classifier than the original XRCA algorithm. Importantly, R3CA is still able to obtain the same performance, or better, as a non-incrementally trained classifier with access to all the class data. These attributes make R3CA an attractive technology for applications requiring rapid online continuous learning of new tasks with streaming data. This type of learning is especially critical for deployed, remote platforms that often lack the disk space required to preserve the large amounts of in-flight data required for further on-board training or the compute power necessary to rapidly digest new information.

Exemplary hardware (also referenced herein as “chip(s)”) and hardware functions for implementing the embodiments described herein are well known and understood to those skilled in the art. Chips for use with the present embodiments include logic functionality implemented through semiconductor devices, e.g., millions or billions of transistors (MOSFET) (also called “nodes”) and electrical interconnects, for creating basic logic gates to perform basic logical operations. These basic logic gates are combined to perform complex high volume, parallel computing required for the training and inference of the embodiments described herein. Chips may also include memory capabilities for storing the data on which the logic functionality is implemented. Exemplary memory capabilities include dynamic random-access memory (DRAM), NAND flash memory and solid-state hard drives.

As referenced above, the training and inference examples described herein were run on an NVIDIA Tesla T4 GPU with 16 GB of GPU memory. Specifications for the NVIDIA Turing GPU architecture can be found in the “NVIDIA Turing GPU Architecture” white paper WP-09183-001_v01 (2018) available on-line which is incorporated herein by reference in its entirety.

One skilled in the art will appreciate that this is but one specific example of a chip which may implement the training and inference embodiments described herein Exemplary chip types include graphics processing units (GPUs), field programmable gate arrays (FPGAs), and application-specific integrated circuits (ASICs). FPGAs include logic blocks (i.e. modules that each contain a set of transistors) whose interconnections can be reconfigured by a programmer after fabrication to suit specific algorithms, while ASICs include hardwired circuitry customized to specific algorithms. The selection of particular hardware includes factors such as computational power, energy efficiency, cost, compatibility with existing hardware and software, scalability, and task (e.g. optimized for training or inference). For a detailed description of AI chip technology, see Khan et al., “AI Chips: What They Are and Why They Matter And AI Chips Reference,” CSET center for Security and Emerging Technology (April 2020) which is incorporated herein by reference in its entirety.

Certain embodiments are directed to a computer program product (e.g., nonvolatile memory device), which includes a machine or computer-readable medium having stored thereon instructions which may be executed by a computer (or other electronic device) to perform these operations/activities.

Although several embodiments have been described above with a certain degree of particularity, those skilled in the art could make numerous alterations to the disclosed embodiments without departing from the spirit of the present disclosure. It is intended that all matter contained in the above description or shown in the accompanying drawings shall be interpreted as illustrative only and not limiting. Changes in detail or structure may be made without departing from the present teachings. The foregoing description and following claims are intended to cover all such modifications and variations.

Various embodiments are described herein of various apparatuses, systems, and methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” “an embodiment,” or the like, means that a particular feature, structure, or characteristic described in connection with the embodiment is included in at least one embodiment. Thus, appearances of the phrases “in various embodiments,” “in some embodiments,” “in one embodiment,” “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation.

Any patent, publication, or other disclosure material, in whole or in part, which is said to be incorporated by reference herein is incorporated herein only to the extent that the incorporated materials do not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

I claim:

1. A system for incrementally training a classifier to continuously learn new classes and classify incoming data, the system comprising:
a processing component for formatting incoming data for feature extraction;
a transformer backbone for
multiplying formatted data with a positional embedding,
transforming, by an encoder, formatted data with positional embedding to produce an encoded vector,
appending a class token to the encoded vector,
a single head incremental classifier trained on known classes including
a classification weight matrix wₖ, where k denotes the kth training update for receiving the encoded vector and determining that the incoming data is in a new class, wherein upon determining that the incoming data is in a new class classification weight matrix is augmented with a new null-class weight vector Δwₖ, and
a feature correlation memory, including a ridge regression penalty applied for regularization,
wherein the single head incremental classifier is trained on training data having feature samples corresponding to the incoming data directed to the new class.

2. The system of claim 1, wherein the transformer backbone is a pretrained, self-supervised, model.

3. The system of claim 1, wherein each column of the classification matrix estimates a likelihood of a different data class.

4. The system of claim 1, wherein augmenting the classification matrix with a new null-class weight vector includes adding a new column for new class weights for the new class.

5. The system of claim 4, further comprising:
initializing the new class weights wherein a new class's column vector weights are weights that have not yet seen any positive class samples and an initial least-squares estimate for the new class weight vector is the recursive solution of all preceding negative training.

6. The system of claim 1, wherein the feature correlation memory is an inverse feature covariance matrix (IFCM), Mₖ.

7. The system of claim 6, wherein computation of the inverse feature covariance matrix (IFCM), Mₖ, uses a ridge regression penalty which is a weighted diagonal loading term λ that determines how much to penalize a solution's use of large weight coefficients.

8. A system for incrementally training a classifier for image classification, the system comprising:
an image processing component for extracting multiple flattened image patches from an input image;
a transformer backbone for
linearly transforming each of the multiple flattened patches, by a patch encoder layer, and mapping the linear transformation to a patch vector,
multiplying each patch vector with a positional embedding,
transforming, by an encoder, each patch vector with positional embedding to produce an encoded patch vector,
appending a class token to the encoded patch vector,
a single head incremental classifier trained on known image classes including a classification weight matrix wₖ, where k denotes the kth training update for receiving the encoded vector and determining that the input image is in a new class, wherein upon determining that the input image is in a new class augmenting the classification weight matrix with a new null-class weight vector Δwₖ, and
a feature correlation memory, including a ridge regression penalty applied for regularization,
wherein the single head incremental classifier is trained on images having feature samples corresponding to the input image directed to the new class.

9. The system of claim 8, wherein the encoder applies multiple self-attention layers to calculate attention weights for each pixel in the input image based on each pixel's relationship with all other pixels in the input image.

10. The system of claim 9, wherein the encoder includes six layers each including twelve heads.

11. The system of claim 8, wherein the transformer backbone is a pretrained, self-supervised, model.

12. The system of claim 11, wherein the pretrained, self-supervised, model is a vision transformer model.

13. The system of claim 8, wherein each column of the classification matrix estimates a likelihood of a different image class.

14. The system of claim 8, wherein augmenting the classification matrix with a new null-class weight vector includes adding a new column for new class weights for the new image class.

15. The system of claim 14, further comprising:
initializing the new class weights wherein a new class's column vector weights are weights that have not yet seen any positive class samples and an initial least-squares estimate for the new class weight vector is the recursive solution of all preceding negative training.

16. The system of claim 8, wherein the feature correlation memory is an inverse feature covariance matrix (IFCM), Mₖ.

17. The system of claim 16, wherein computation of the inverse feature covariance matrix (IFCM), Mₖ, uses a ridge regression penalty which is a weighted diagonal loading term λ that determines how much to penalize a solution's use of large weight coefficients.

18. A non-transitory computer-readable storage medium having computer-executable instructions stored thereon for predicting an image class, which when executed by one or more processors, cause the one or more processors to perform operations comprising:
extracting multiple flattened image patches from an input image;
linearly transforming each of the multiple flattened patches, by a patch encoder layer, and mapping the linear transformation to a patch vector;
multiplying each patch vector with a positional embedding;
transforming, by an encoder, each patch vector with positional to produce an encoded patch vector;
appending a class token to the encoded patch vector;
receiving the encoded patch vector at a classifier and determining by a classification weight matrix that the image is in a new class;
augmenting the classification weight matrix with a new null-class weight vector; and
training the incremental classifier on images having feature samples corresponding to the input image directed to the new class.

19. The non-transitory computer-readable storage medium of claim 12, wherein augmenting the classification weight matrix with a new null-class weight vector includes adding a new column for new class weights for the new topic class.

20. The non-transitory computer-readable storage medium of claim 13, further comprising:
initializing the new class weights wherein a new class's column vector weights are weights that have not yet seen any positive class samples and an initial least-squares estimate for the new class weight vector is the recursive solution of all the preceding negative training.
